(19) United States
(12) Patent Application Publication
(10) Pub. No.: US 2009/0000546 A1
(43) Pub. Date: Jan. 1, 2009

(54) DISPENSING SYSTEM AND METHOD OF USE

(76) Inventors: Kenneth J. Rueschhoff, Wildwood, MO (US); Joseph C. Lott, Des Peres, MO (US)

Correspondence Address: HARNESS, DICKEY, & PIERCE, P.L.C, 7700 Bonhomme, Suite 400, ST. LOUIS, MO, 63105, US

(21) Appl. No.: 12/147,757

(22) Filed: Jun. 27, 2008

Related U.S. Application Data
(60) Provisional application No. 60/946,713, filed on Jun. 27, 2007.

(51) Int. Cl. B05C 11/00; B29B 7/76; G01F 11/00

(52) U.S. Cl. 118/679; 422/133; 222/389

(57) ABSTRACT

A method of dispensing polyurethane foam from DOT-39 compliant tank, the method includes providing DOT-39 compliant tanks of each of the components of the polyurethane foam, each tank having at least two valves. At least one valve of each of the DOT-39 compliant tanks is connected to a source of pressure. At least one valve of each of the DOT-39 compliant tanks is connected to a dispenser to mix the components and dispense the foam under pressure.

### BACKGROUND OF THE INVENTION

This invention relates to dispensing systems and methods of dispensing materials, such as polyurethane foams.

Polyurethane foams have a wide variety of applications, but are particular useful in the construction industry for filling, sealing, insulating, and providing sound attenuation. For this reason, relatively large quantities of polyurethane foam must be transported to, and dispensed at, remote construction sites. Most of the foam is transported as components in disposable or single use, pressurized DOT-39 compliant tanks. DOT-39 (49 CFR §178.65) provides specifications for relatively light weight, nonrefillable containers. These are desirable for this application because the containers can be made less expensively than refillable containers, and typically weigh less than refillable containers, which makes them easier to transport and handle. At the job site the tanks of the separate components are connected to a dispenser, and dispensed. After the materials are dispensed, the spent tanks are simply discarded.

However dispensing foam from the DOT-39 compliant containers is complicated by the fact that dispensing rates can diminish by as much as 50% or more as the contents of the tanks are used. Furthermore foam properties can vary as well, for example the density of the dispensed foam can vary by as much as 20% or more as the contents of the tank are used. Another difficulty with DOT-39 containers is their disposal. These containers can often only be filled to a maximum of about 60% due to the container volume required for propellant, thus a relatively large number of containers must be used for a given project, and once the foam has been dispensed the tanks must be disposed of. Disposal is further complicated by the fact that most of these tanks employ a dip tube system for extracting the contents of the tank. Because of manufacturing tolerances, the construction of these tanks and dip tube systems varies such that undispensed material is almost always left in the container. This is wasteful and it complicates recycling or other disposal methods of the spent containers. It is estimated that as much as 5% of the material is these containers may remain undispensed.

### SUMMARY

This disclosure relates to improved systems and methods for dispensing materials such as polyurethane foams from DOT-39 compliant containers.

According to one aspect, embodiments of the present invention provide a DOT-39 compliant system for dispensing material under pressure. The system preferably comprises a tank compliant with DOT-39 having at least two valves, and a charge of material to be dispensed. A pressure system is connected to at least one of the tank's valves for pressurizing or maintaining pressure in the tank. A dispenser is connected to another of the tank's valves for dispensing the material from the tank.

According to another aspect, embodiments of the present invention provide a DOT-39 compliant system for dispensing material formed from at least two components under pressure. The system comprises at least two tanks, each of which is compliant with DOT-39 and having at least two valves, and a charge of one of the components of the material to be dispensed. A pressure system is connected to at least one of each of the tank's valves for pressurizing or maintaining pressure in the tanks. A dispenser is connected to at least one of each of the tank's valves for mixing the components from the tank, and dispensing the material.

In the preferred embodiments of the systems of this invention, the tanks have at an upper valve adjacent the top of the tank, and a lower valve adjacent the bottom of the tank. The upper valve can be used for connection to a pressure system, the lower valve can be used for connection to dispensing system.

In still another aspect, embodiments of this invention provide a method for the pressure dispensing of a material at a remote location. This method can include transporting the material to be dispensed to the remote location in a tank compliant with DOT-39 and having at least two valves. A source of pressure is connected to at least one of valves of the tank. A dispenser is connected to at least one of the valves of the tank. In still another aspect, embodiments of this invention provide a DOT-39 compliant tank of a polyurethane foam component in which the component fills at least 70% of the volume of the tank, and more preferably at least 90% of the volume of the tank. The tank preferably has at least two valves, and more preferably one of the valves is located in the upper portion of the tank, and one of the valves is located in the lower portion of the tank.

In still another aspect, embodiments of the invention provide a method of dispensing foam from DOT-39 compliant tanks at multiple locations. The DOT-39 compliant tanks are connected to a source of pressure to dispense foam at the first site. The DOT-39 compliant tanks are disconnected from the pressure source and transported to a second site. At the second site the DOT-39 complaint tanks are connected to a source of pressure to dispense foam at the second site.

The various embodiments of the present invention provides systems and methods for dispensing materials, and particularly polyurethane foam, from DOT-39. The various systems and methods reduce or eliminate some or all of the difficulties encountered with conventional DOT-39 compliant dispensing systems. The various systems and methods also reduce some of the difficulties encountered in disposing of spent DOT-39 containers, by reducing the number of such containers, and reducing the amounts of undispensed material left in the spent containers. These and other possible features and advantages will be in part apparent and in part pointed out hereinafter.

### BRIEF DESCRIPTION OF THE DRAWINGS

FIG. 1 is a diagram showing a conventional foam dispensing system employing conventional DOT-39 compliant component tanks;

FIG. 2 is a diagram of a preferred embodiment of a foam dispensing system in accordance with the principles of the present invention.

### DETAILED DESCRIPTION

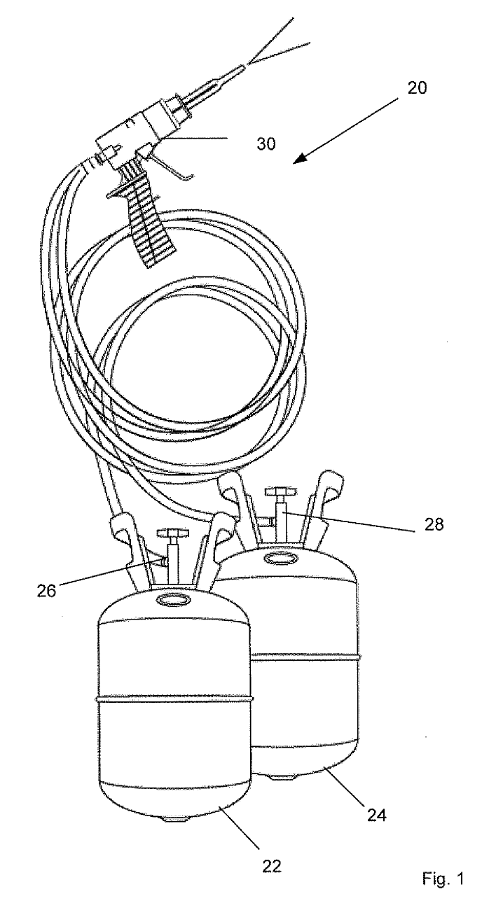

A conventional foam dispensing system employing conventional DOT-39 compliant tanks is indicated generally as 20 in FIG. 1. The system 20 comprises first and second containers 22 and 24 that are DOT-39 compliant. Each of the containers 22 and 24 holds a component of a polyurethane foam. Container 22 has a valve 26 for connecting the container to a dispenser 30. Similarly container 24 has a valve 28 for connecting the container to the dispenser 30. The dispenser 30 has controls (e.g. a trigger) for operating the dispenser to mix the components, and dispense foam. The dispensing rate from the system 20 varies with time, being greater when the containers are full, and diminishing as the containers empty. The properties of the foam being dispensed are also affected by the varying internal pressures and resultant dispensing rates during the dispensing process. When the contents of the tanks 22 and 24 are exhausted, the dispenser is disconnected from the tanks, and the tanks are disposed of. Because of the design of the tanks, there is typically residual material left in the tanks, which can complicate their disposal or recycling.

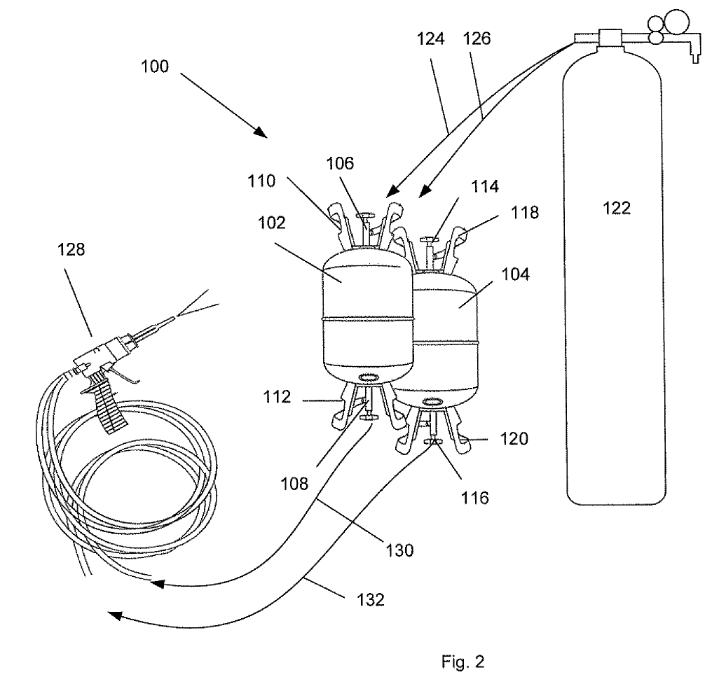

A preferred embodiment of a system for dispensing material in accordance with the principles of the present invention is indicated generally as 100 in FIG. 2. The system 100 comprises first and second containers 102 and 104 that are DOT-39 compliant. Each of the containers 102 and 104 holds a component of a polyurethane foam. Container 102 has at least two valve 106 and 108. Valve 106 is preferably located in the upper portion of the container 102 (most preferably at the top), and may be surrounded by a protective cage 110. Valve 106 is preferably located in the lower portion of the container 102 (most preferably at the bottom), and may be surrounded by a protective cage 112, that also forms a stand for the container. Similarly, container 104 has at least two valves 114 and 116. Valve 114 is preferably located in the upper portion of the container 104 (most preferably at the top), and may be surrounded by a protective cage 118. Valve 116 is preferably located in the lower portion of the container 104 (most preferably at the bottom), and may be surrounded by a protective cage 120 that also forms a stand for the container.

Because containers 102 and 104 each have at least two valves, each can be connected to a source of pressure without interfering with the ability to access the material in the container. Thus, as shown, each of the containers 102 and 104 is connected to a source of pressure, such as a regulated gas cylinder 122, via hoses 124 and 126 connected to valves 106 and 114, respectively. Of course some other source of pressure could be used, such a compressor. Furthermore, while the source of pressure is preferably at a constant pressure, this is not critical. In the preferred embodiment, where the source of pressure is a source of constant pressure, the containers 102 and 104 will be maintained at a relatively constant pressure, which improves dispensing time, and the consistency of the foam being dispensed.

The connection to an external source of pressure also means that the containers 102 and 104 are not dependent solely upon their internal pressure to dispense their contents. This means that for a given size container, more of the volume can be used for the material to be dispensed, and less of the volume is used for propellant. Furthermore, a more consistent pressurization results in a more consistent dispensing rate, which also means more consistent properties (such as density) of the dispensed foam.

A dispenser 128 can be connected to the containers 102 and 104 via hoses 130 and 132 connected to valves 108 and 116, respectively. The connection to the containers 102 and 104 from valves at the bottom means that the material can be more completely drained from the containers. This means that more of the material loaded into the containers is available for use, and that there will be less remnants in the container to impair recycling of the containers.

The system of the invention can be used to dispense foams of any density, from 0.5 pounds per cubic foot to about 6 pounds per cubic foot.

While the preferred embodiment of the system is particularly adapted for use in transporting and dispensing two part urethane foams, the invention is not so limited and can be used in delivering other multipart substances, such as epoxies, polyurea, polyester styrene and silicones, and even single part substances such as paints/coatings, adhesives and sealants.

What is claimed is:

1. A DOT-39 compliant system for dispensing material under pressure, the system comprising:
a tank compliant with DOT-39 having at least two valves, and a charge of material to be dispensed;
a pressure system connected to at least one of the tank's valves for pressurizing or maintaining pressure in the tank; and
a dispenser connected to at least one of the tank's outlet valves for dispensing the material from the tank.

2. The system according to claim 1 wherein the tank has at least an upper valve adjacent the top of the tank, and a lower valve adjacent the bottom of the tank.

3. The system according to claim 2 wherein the valves are arranged so that less than about 1% of the initial fill weight remains when the container is emptied.

4. The system according to claim 1 wherein two valves are connected to the tank at a single location.

5. A DOT-39 compliant system for dispensing material formed from at least two components under pressure, the system comprising:
at least two tanks, each tank compliant with DOT-39 and having at least two valves, and a charge of one of the components of the material to be dispensed;
a pressure system connected to at least one of each of the tank's valves for pressurizing or maintaining pressure in the tanks; and
a dispenser connected to at least one of each of the tank's valves for mixing the components from the tank, and dispensing the material.

6. The system according to claim 5 wherein the tank has at least an upper valve adjacent the top of the tank, and a lower valve adjacent the bottom of the tank.

7. The system according to claim 5 wherein the valves are arranged so that less than about 1% of the initial fill weight remains when the container is emptied.

8. The system according to claim 5 wherein two valves are connected to at least one of the tanks at a single location.

9. A method for the pressure dispensing of a material at a remote location, the method comprising:
transporting the material to be dispensed to the remote location in a tank compliant with DOT-39, and having at least two valves;
connecting a source of pressure to at least one of valves of the tank;
connecting a dispenser to at least one of the valves of the tank.

10. The DOT-39 compliant tank of a polyurethane foam component of claim 7 in which the tank has at least two valves.

11. The DOT-39 compliant tank of a polyurethane foam component of claim 10 wherein the valves are arranged so that less than about 1% of the initial fill weight remains when the container is emptied.

12. A method of dispensing polyurethane foam from DOT-39 compliant tank, the method comprising:
providing DOT-39 compliant tanks of each of the components of the polyurethane foam, each tank having at least two valves;
connecting at least one valve of each of the DOT-39 compliant tanks to a source of pressure;
connecting at least one valve of each of the DOT-39 compliant tanks to a dispenser to mix the components and dispense the foam under pressure.

13. A method of dispensing polyurethane foam from DOT-39 compliant tanks, the method comprising connecting DOT-39 tanks containing each of the components of the foam to a pressure source to deliver the components to a dispenser under substantially constant pressure.

14. The method according to claim 13 wherein at least one of the tanks is filled to at least about 70 percent of capacity.

15. The method according to claim 14 wherein at least one of the tanks is filled to at least about 90 percent of capacity.

16. The method according to claim 13 further comprising delivering at least 99 per cent of the initial fill volume of the DOT-39 tank in which at least one of the components was stored.

17. The method according to claim 13 wherein the foam density at the start of dispensing and the foam density at the completion of dispensing varies by no more than about 8 percent when no other system changes are imposed,

18. The method according to claim 13 wherein the dispensing rate at the start of dispensing and the dispensing rate at the completion of dispensing various by no more than about 15 percent when no other system changes are imposed.

19. A method of dispensing foam from DOT-39 compliant tanks at multiple locations comprising connecting the DOT-39 compliant tanks at a first site to a source of pressure to dispense foam at the first site; disconnecting the DOT-39 compliant tanks from the source of pressure, transporting the DOT-39 tanks at a second site, connecting the DOT-39 complaint tanks at the second size to a source of pressure to dispense foam at the second site.

20. The method according to claim 19 further comprising relieving at least some of the pressure from the DOT-39 compliant tanks before transporting them.
